(19) United States
(12) Patent Application Publication
(10) Pub. No.: US 2026/0116653 A1
(43) Pub. Date: Apr. 30, 2026

(54) SYSTEMS AND METHODS FOR OPERATING AN ACTUATOR OF A REFUSE VEHICLE

(71) Applicant: Oshkosh Corporation, Oshkosh, WI (US)

(72) Inventors: Cole Adams, Oshkosh, WI (US); Chris Rukas, Oshkosh, WI (US); Wesley Van Pelt, Oshkosh, WI (US)

(73) Assignee: Oshkosh Corporation, Oshkosh, WI (US)

(21) Appl. No.: 19/368,419

(22) Filed: Oct. 24, 2025

Related U.S. Application Data
(60) Provisional application No. 63/712,084, filed on Oct. 25, 2024.
(60) Provisional application No. 63/741,712, filed on Jan. 3, 2025.

(51) Int. Cl. B65F 3/02

(52) U.S. Cl. CPC B65F 3/02; B65F 2003/0259

(57) ABSTRACT

A refuse vehicle includes a chassis, a body coupled to the chassis, a lift apparatus coupled to at least one of the chassis or the body and configured to collect refuse and one or more processing circuits. The one or more processing circuits are configured to operate the actuator with a first speed, acquire position data corresponding to a position of the movable body, and responsive to the position of the movable body being within a derating range, operate the actuator with a second speed, the second speed slower than the first speed.

### CROSS-REFERENCE TO RELATED APPLICATIONS

This application claims the benefit of and priority to U.S. Provisional Patent Application No. 63/712,084 filed Oct. 25, 2024, and U.S. Provisional Patent Application No. 63/741,712, filed Jan. 3, 2025, the entire contents of each of which are hereby incorporated by reference herein.

### BACKGROUND

The present disclosure generally relates to the field of refuse vehicles. More specifically, the present disclosure relates to control systems for refuse vehicles.

### SUMMARY

An exemplary embodiment of the present disclosure relates to a refuse vehicle. The refuse vehicle includes a chassis, a body coupled to the chassis, a lift apparatus coupled to at least one of the chassis or the body and configured to collect refuse and one or more processing circuits. The one or more processing circuits are configured to operate the actuator with a first speed, acquire position data corresponding to a position of the movable body, and responsive to the position of the movable body being within a derating range, operate the actuator with a second speed, the second speed slower than the first speed.

Another exemplary embodiment of the present disclosure relates to a refuse vehicle. The refuse vehicle includes a chassis, a body coupled to the chassis, a lift apparatus coupled to at least one of the chassis or the body and configured to collect refuse and one or more processing circuits. The lift apparatus includes a movable body and an actuator configured to move the movable body between a first position and a second position. The one or more processing circuits are configured to operate the actuator with a first speed, acquire position data corresponding to a position of the movable body between the first position and the second position, determine, based on the position of the movable body, a derating factor for the actuator, determine, based on the first speed and the derating factor, a second speed for the actuator, and operate the actuator with the second speed.

Yet another exemplary embodiment of the present disclosure relates to a method of operating an actuator of a refuse vehicle. The method includes operating the actuator with a first speed to drive a movable body between a first position and a second position, acquiring position data corresponding to a position of the movable body, and responsive to the position of the movable body being within a derating range, operating the actuator with a second speed, the second speed slower than the first speed.

Yet another exemplary embodiment of the present disclosure relates to a refuse vehicle. The refuse vehicle includes a chassis, a body coupled to the chassis, a lift apparatus coupled to at least one of the chassis or the body and configured to collect refuse, a component, and processing circuitry. The lift apparatus includes a movable body and an actuator configured to drive the movable body between a first position and a second position. The component is configured to generate position data associated with a position of the movable body. The processing circuitry is configured to operate the actuator with a first speed, acquire, from the component, the position data, and responsive to the position of the movable body being within a derating range, operate the actuator with a second speed, the second speed slower than the first speed.

This summary is illustrative only and is not intended to be in any way limiting. Other aspects, inventive features, and advantages of the devices or processes described herein will become apparent in the detailed description set forth herein, taken in conjunction with the accompanying figures, wherein like reference numerals refer to like elements.

### BRIEF DESCRIPTION OF THE DRAWINGS

The disclosure will become more fully understood from the following detailed description, taken in conjunction with the accompanying figures, wherein like reference numerals refer to like elements, in which:

FIG. 1 is a perspective view of a front-loading refuse vehicle, according to an exemplary embodiment;

FIG. 2 is a side view of a rear-loading refuse vehicle, according to an exemplary embodiment;

FIG. 3 is a perspective view of a side-loading refuse vehicle, according to an exemplary embodiment;

FIG. 4 is a perspective view of a lift system of the side-loading refuse vehicle of FIG. 3, according to an exemplary embodiment;

FIG. 5 is a side view of the lift system of FIG. 4 and a reach assembly of the side-loading refuse vehicle of FIG. 3 in a retracted position, according to an exemplary embodiment;

FIG. 6 is a side view of the lift system of FIG. 4 and the reach assembly of FIG. 5 in an extended position, according to an exemplary embodiment;

FIG. 7 is a block diagram of a control system for any of the refuse vehicles of FIGS. 1-3, according to an exemplary embodiment;

FIG. 8 is an actuator derating chart implemented by the control system of FIG. 7, according to an exemplary embodiment;

FIG. 9 is the actuator derating chart of FIG. 8, according to an exemplary embodiment;

FIG. 10 is the actuator derating chart of FIG. 8, according to an exemplary embodiment;

FIG. 11 is a reach assembly derating chart implemented by the control system of FIG. 7 for the reach assembly of FIG. 5, according to an exemplary embodiment;

FIG. 12 is a front view of a grabber assembly of the lift system of FIG. 4, according to an exemplary embodiment;

FIG. 13 is a flow chart of a method for operating an actuator of any of the refuse vehicles of FIGS. 1-3, according to an exemplary embodiment; and

FIG. 14 is a block diagram of a portion of the control system of FIG. 7 and a portion of the reach assembly of FIG. 5, according to an exemplary embodiment.

### DETAILED DESCRIPTION

Before turning to the figures, which illustrate the exemplary embodiments in detail, it should be understood that the present application is not limited to the details or methodology set forth in the description or illustrated in the figures. It should also be understood that the terminology is for the purpose of description only and should not be regarded as limiting.

### Overview

Referring generally to the Figures, a refuse vehicle includes a controller configured to derate a speed of an actuator based on a position of a movable body that is driven by the actuator. The controller may derate the speed of the actuator based on position data associated with the movable body that is generated by a component associated with the actuator. For example, a sensor may be configured to generate position data associated with a position of an extension arm that is driven by a motor between a retracted position and an extended position. By way of another example, an inverter configured to drive an electric motor may be configured to generate position data associated with a position of an extension arm that is driven by the electric motor between a retracted position and an extended position based on back electromotive forces (e.g., a voltage that opposes changes of currents in the electric motor, etc.) received by the inverter from the electric motor. A controller may receive the position data and slow down a speed of the motor as the extension arm approaches the retracted position and/or the extended position such that the extension arm does not reach the extended position and/or the retracted position while traveling at full speed. In some embodiments, the controller receives distance data associated with a distance between the extension arm and an object and slows down the speed of the motor as the extension arm approaches the object such that the extension arm does not contact the object while traveling at full speed. In some embodiments, the controller is configured to calibrate the component (e.g., a sensor) generating the position data when the extension arm is in the retracted position to ensure that the controller accurately derates the speed of the motor based on the position of the extension arm.

### Refuse Vehicle

### Front-Loading Configuration

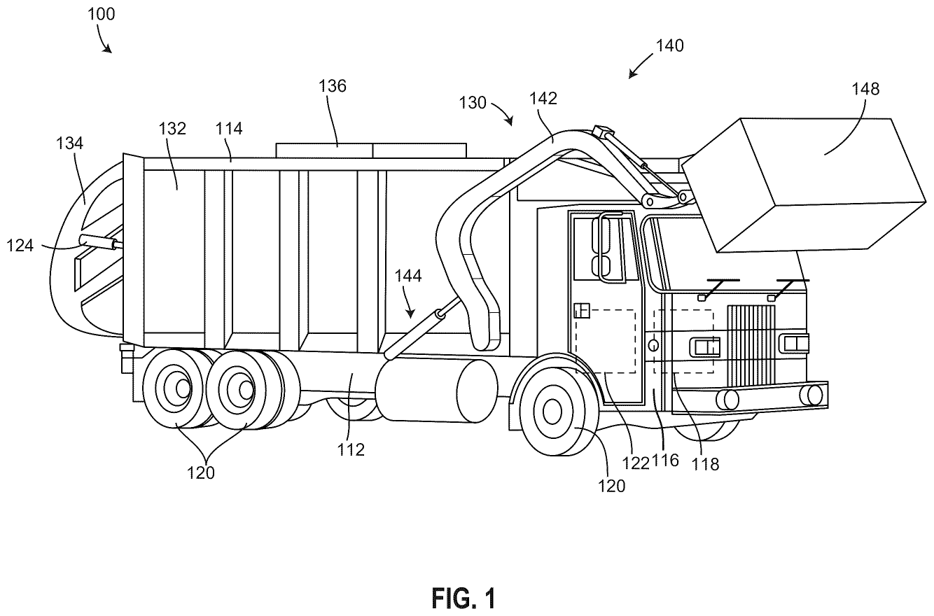

Referring to FIG. 1, a vehicle, shown as refuse vehicle 100 (e.g., a garbage truck, a waste collection truck, a sanitation truck, etc.), is shown that is configured to collect and store refuse along a collection route. In the embodiment of FIG. 1, the refuse vehicle 100 is configured as a front-loading refuse vehicle. The refuse vehicle 100 includes a chassis, shown as frame 112; a body assembly, shown as body 114, coupled to the frame 112 (e.g., at a rear end thereof, etc.); and a cab, shown as cab 116, coupled to the frame 112 (e.g., at a front end thereof, etc.). The cab 116 may include various components to facilitate operation of the refuse vehicle 100 by an operator (e.g., a seat, a steering wheel, hydraulic controls, a user interface, an acceleration pedal, a brake pedal, a clutch pedal, a gear selector, switches, buttons, dials, etc.). As shown in FIG. 1, the refuse vehicle 100 includes a prime mover, shown as engine 118, coupled to the frame 112 at a position beneath the cab 116. The engine 118 is configured to provide power to tractive elements, shown as tractive elements 120, and/or to other systems of the refuse vehicle 100 (e.g., a pneumatic system, a hydraulic system, etc.). The engine 118 may be configured to utilize one or more of a variety of fuels (e.g., gasoline, diesel, bio-diesel, ethanol, natural gas, etc.), according to various exemplary embodiments. The fuel may be stored in a tank 128 (e.g., a vessel, a container, a capsule, etc.) that is fluidly coupled with the engine 118 through one or more fuel lines.

According to an alternative embodiment, the engine 118 additionally or alternatively includes one or more electric motors coupled to the frame 112 (e.g., a hybrid refuse vehicle, an electric refuse vehicle, etc.). The electric motors may consume electrical power from any of an on-board storage device (e.g., batteries, ultra-capacitors, etc.), from an on-board generator (e.g., an internal combustion engine, etc.), or from an external power source (e.g., overhead power lines, etc.) and provide power to the systems of the refuse vehicle 100. The engine 118 may transfer output torque to or drive the tractive elements 120 (e.g., wheels, wheel assemblies, etc.) of the refuse vehicle 100 through a transmission. The engine 118, the transmission 122, and one or more shafts, axles, gearboxes, etc., may define a driveline of the refuse vehicle 100.

According to an exemplary embodiment, the refuse vehicle 100 is configured to transport refuse from various waste receptacles within a municipality to a storage and/or processing facility (e.g., a landfill, an incineration facility, a recycling facility, etc.). As shown in FIG. 1, the body 114 includes a plurality of panels, shown as panels 132, a tailgate 134, and a cover 136. The panels 132, the tailgate 134, and the cover 136 define a collection chamber (e.g., hopper, etc.), shown as refuse compartment 130. Loose refuse may be placed into the refuse compartment 130 where it may thereafter be compacted. The refuse compartment 130 may provide temporary storage for refuse during transport to a waste disposal site and/or a recycling facility. In some embodiments, at least a portion of the body 114 and the refuse compartment 130 extend in front of the cab 116. According to the embodiment shown in FIG. 1, the body 114 and the refuse compartment 130 are positioned behind the cab 116. In some embodiments, the refuse compartment 130 includes a hopper volume and a storage volume. Refuse may be initially loaded into the hopper volume and thereafter transferred and/or compacted into the storage volume. According to an exemplary embodiment, the hopper volume is positioned forward of the cab 116 (e.g., refuse is loaded into a portion of the refuse compartment 130 in front of the cab 116, a front-loading refuse vehicle, etc.). In other embodiments, the hopper volume is positioned between the storage volume and the cab 116 (e.g., refuse is loaded into a portion of the refuse compartment 130 behind the cab 116 and stored in a portion further toward the rear of the refuse compartment 130). In yet other embodiments, the storage volume is positioned between the hopper volume and the cab 116 (e.g., a rear-loading refuse vehicle, etc.).

The tailgate 134 may be hingedly or pivotally coupled with the body 114 at a rear end of the body 114 (e.g., opposite the cab 116). The tailgate 134 may be driven to rotate between an open position and a closed position by tailgate actuators 124. The refuse compartment 130 may be hingedly or pivotally coupled with the frame 112 such that the refuse compartment 130 can be driven to raise or lower while the tailgate 134 is open in order to dump contents of the refuse compartment 130 at a landfill. The refuse compartment 130 may include a packer assembly (e.g., a compaction apparatus) positioned therein that is configured to compact loose refuse.

Referring still to FIG. 1, the refuse vehicle 100 includes a first lift mechanism or system (e.g., a front-loading lift assembly, etc.), shown as lift assembly 140. The lift assembly 140 includes a pair of arms, shown as lift arms 142, coupled to at least one of the frame 112 or the body 114 on either side of the refuse vehicle 100 such that the lift arms 142 extend forward of the cab 116 (e.g., a front-loading refuse vehicle, etc.). The lift arms 142 may be rotatably coupled to frame 112 with a pivot (e.g., a lug, a shaft, etc.). The lift assembly 140 includes first actuators, shown as lift arm actuators 144 (e.g., hydraulic cylinders, etc.), coupled to the frame 112 and the lift arms 142. The lift arm actuators 144 are positioned such that extension and retraction thereof rotates the lift arms 142 about an axis extending through the pivot, according to an exemplary embodiment. The lift arms 142 may be removably coupled to a container, shown as refuse container 148 in FIG. 1. The lift arms 142 are configured to be driven to pivot by lift arm actuators 144 to lift and empty the refuse container 148 into the hopper volume for compaction and storage. The lift arms 142 may be coupled with a pair of forks or elongated members that are configured to removably couple with the refuse container 148 so that the refuse container 148 can be lifted and emptied. The refuse container 148 may be similar to the container attachment described in greater detail in U.S. application Ser. No. 17/558,183, filed Dec. 12, 2021, the entire disclosure of which is incorporated by reference herein.

### Rear-Loading Configuration

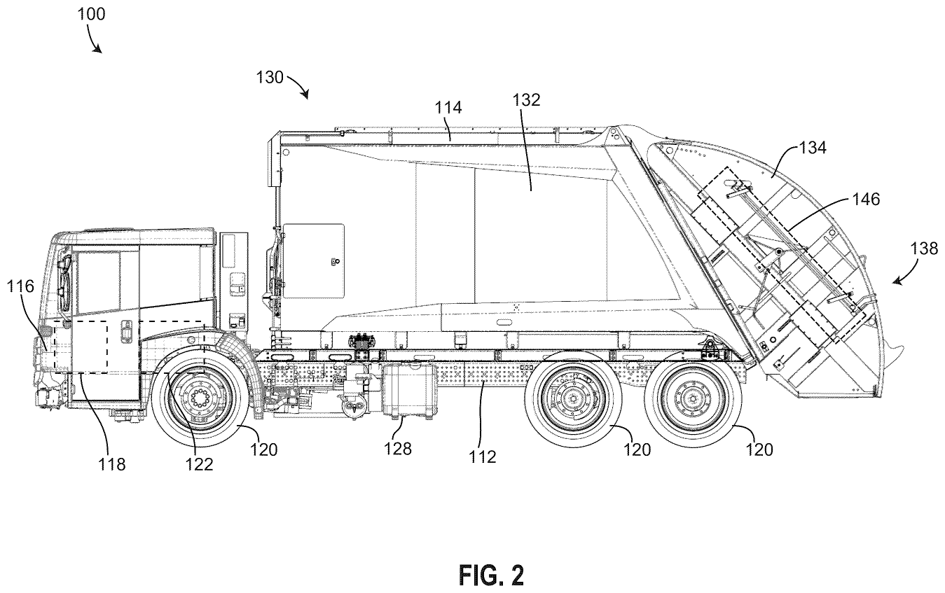

As shown in FIG. 2, the refuse vehicle 100 may be configured as a rear-loading refuse vehicle, according to some embodiments. In the rear-loading embodiment of the refuse vehicle 100, the tailgate 134 defines an opening 138 through which loose refuse may be loaded into the refuse compartment 130. The tailgate 134 may also include a packer 146 (e.g., a packing assembly, a compaction apparatus, a claw, a hinged member, etc.) that is configured to draw refuse into the refuse compartment 130 for storage. Similar to the embodiment of the refuse vehicle 100 described in FIG. 1 above, the tailgate 134 may be hingedly coupled with the refuse compartment 130 such that the tailgate 134 can be opened or closed during a dumping operation.

### Side-Loading Configuration

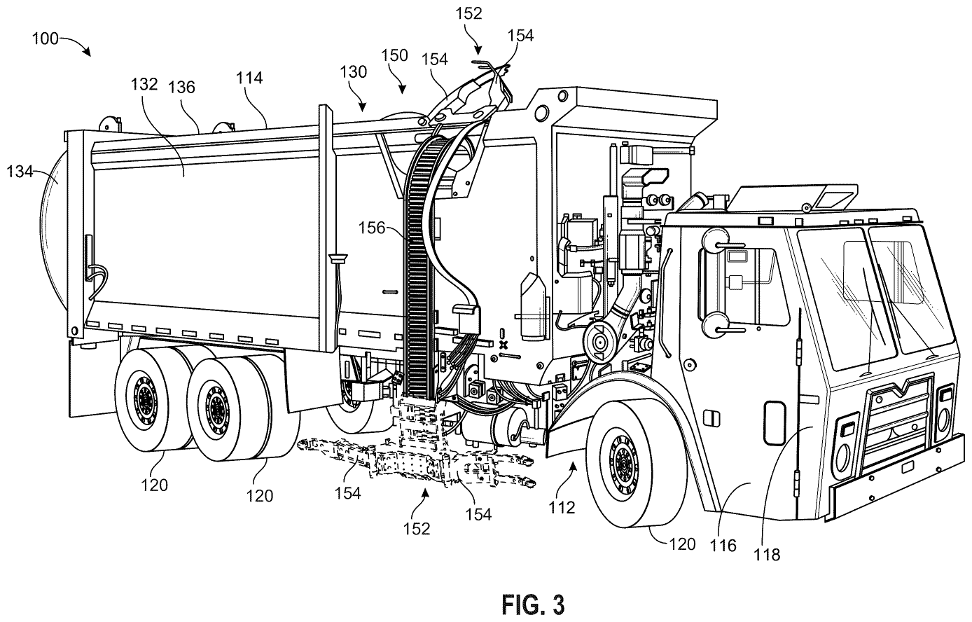

As shown in FIG. 3, the refuse vehicle 100 may be configured as a side-loading refuse vehicle (e.g., a zero radius side-loading refuse vehicle). The refuse vehicle 100 includes first lift mechanism or system, shown as lift assembly 150. Lift assembly 150 includes a grabber assembly, shown as grabber assembly 152, movably coupled to a track, shown as track 156, and configured to move along an entire length of the track 156. According to the exemplary embodiment shown in FIG. 3, track 156 extends along substantially an entire height of body 114 and is configured to cause grabber assembly 152 to tilt near an upper height of body 114. In other embodiments, the track 156 extends along substantially an entire height of body 114 on a rear side of body 114.

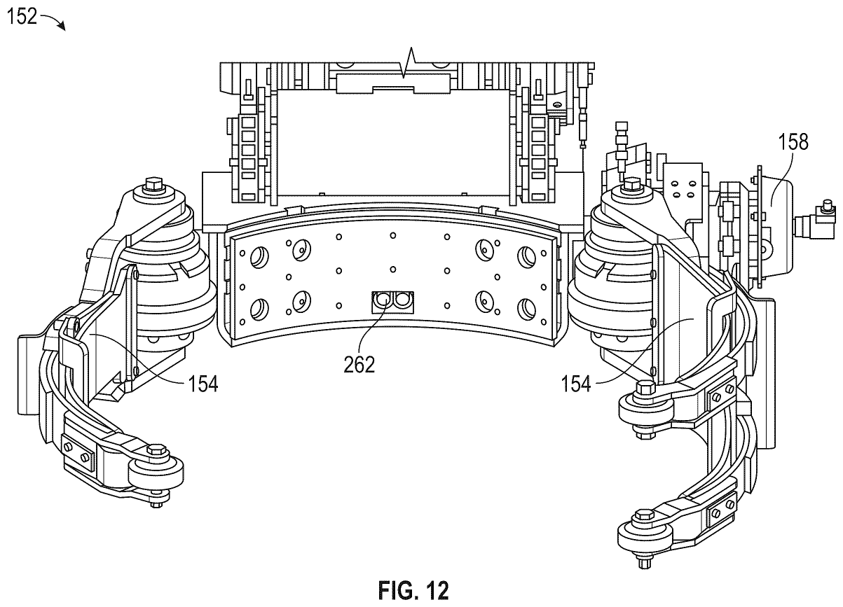

As shown in FIG. 3, grabber assembly 152 includes a pair of grabber arms shown as grabber arms 154. The grabber arms 154 are configured to rotate about an axis extending through a bushing. The grabber arms 154 are configured to releasably secure a refuse container to grabber assembly 152, according to an exemplary embodiment. The grabber arms 154 rotate about the axis extending through the bushing to transition between an engaged state (e.g., a fully grasped configuration, a fully grasped state, a partially grasped configuration, a partially grasped state) and a disengaged state (e.g., a fully open state or configuration, a fully released state/configuration, a partially open state or configuration, a partially released state/configuration). In the engaged state, the grabber arms 154 are rotated towards each other such that the refuse container is grasped therebetween. In the disengaged state, the grabber arms 154 rotate outwards such that the refuse container is not grasped therebetween. By transitioning between the engaged state and the disengaged state, the grabber assembly 152 releasably couples the refuse container with grabber assembly 152. The refuse vehicle 100 may pull up along-side the refuse container, such that the refuse container is positioned to be grasped by the grabber assembly 152 therebetween. The grabber assembly 152 may then transition into an engaged state to grasp the refuse container. A1fter the refuse container has been securely grasped, the grabber assembly 152 may be transported along track 156 with the refuse container. When the grabber assembly 152 reaches the end of track 156, the grabber assembly 152 may tilt and empty the contents of the refuse container in refuse compartment 130. The tilting is facilitated by the path of the track 156. When the contents of the refuse container have been emptied into refuse compartment 130, the grabber assembly 152 may descend along the track 156, and return the refuse container to the ground. Once the refuse container has been placed on the ground, the grabber assembly may transition into the disengaged state, releasing the refuse container. As shown in FIG. 12, the grabber assembly 152 includes a grabber arm actuator 158 (e.g., a piston, a motor, etc.) configured to transition the grabber arms 154 between the engaged state and the disengaged state.

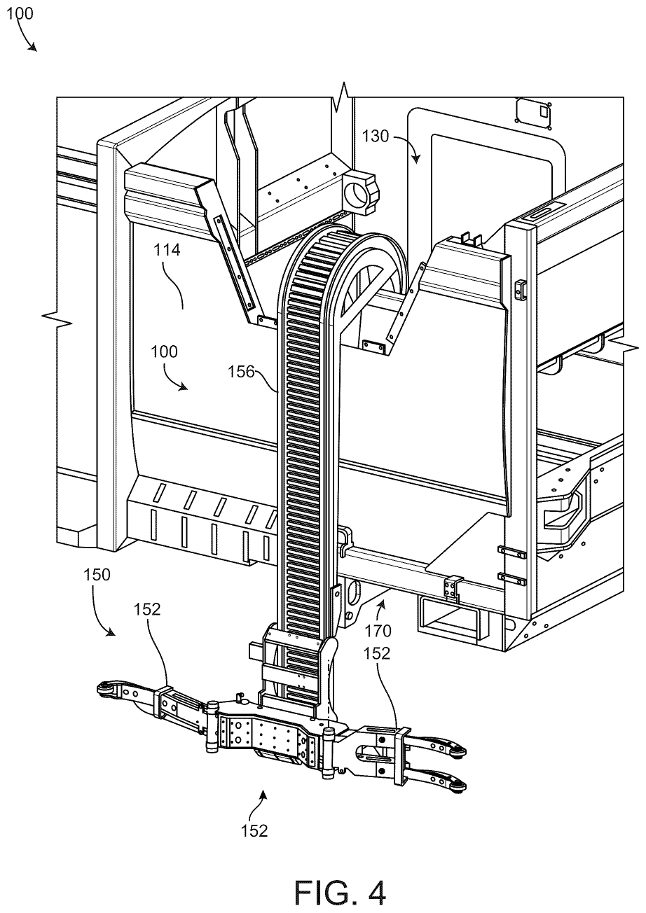

As shown in FIGS. 4-6, the refuse vehicle 100 includes a reach assembly 170 configured to operate to facilitate extension and/or retraction of the grabber assembly 152 and/or the lift assembly 150. The reach assembly 170 may be configured to extend and/or retract from a side (e.g., a lateral side, etc.) of the refuse vehicle 100 to facilitate lateral reach for the grabber assembly 152 to releasably grasp refuse containers that may be positioned a lateral distance from the refuse vehicle 100 (e.g., on a curbside, etc.). In some embodiments, the reach assembly 170 is configured to extend and/or retract to laterally translate the grabber assembly 152 and/or the lift assembly 150. In some embodiments, the reach assembly 170 is configured to extend and/or retract to laterally translate the grabber assembly 152 and a portion of the lift assembly 150 (e.g., a portion of the track 156, etc.). The reach assembly 170 may be coupled to the frame 112 and/or the body 114 of the refuse vehicle 100.

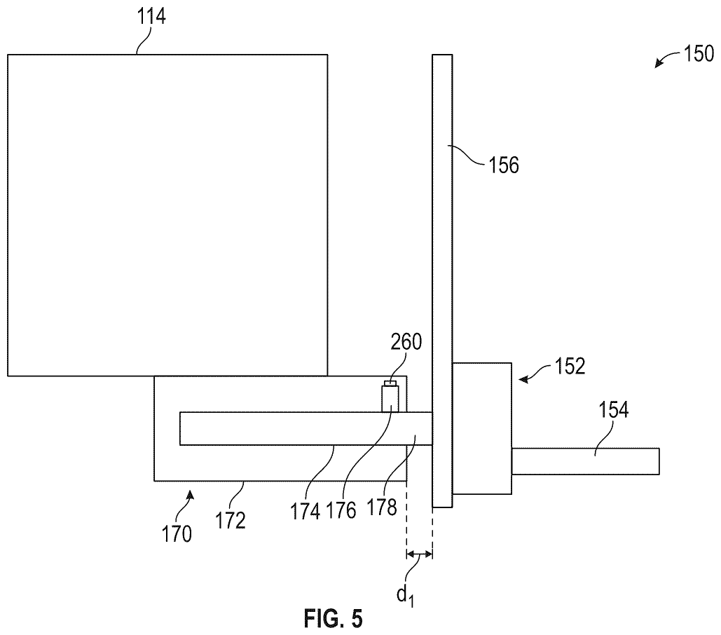

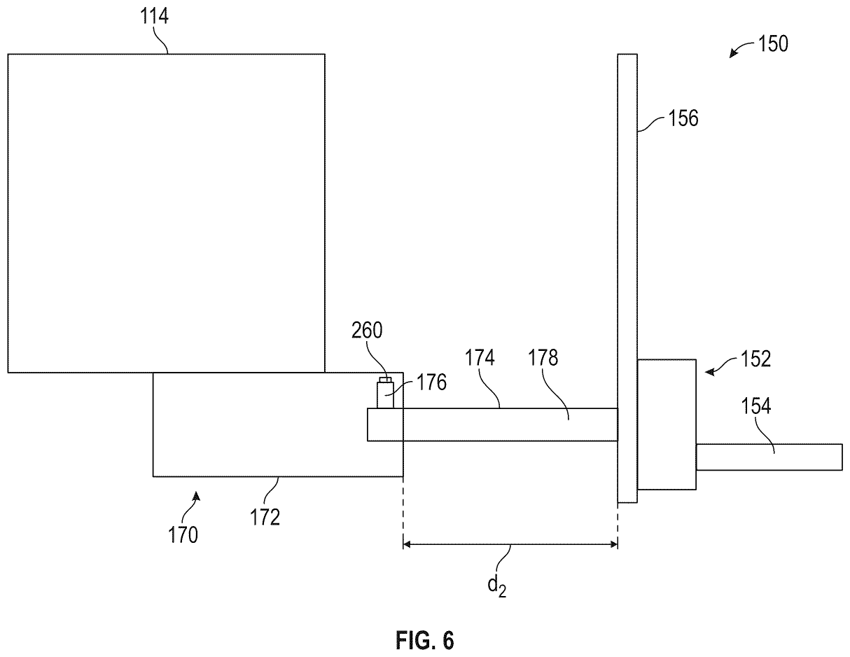

As shown in FIGS. 5 and 6, the reach assembly 170 includes a main body 172, an extension body 174 slidably coupled to the main body 172, and an extension actuator 176 (e.g., a piston, a motor, a linear actuator, etc.) coupled to the main body 172 and the extension body 174. According to an exemplary embodiment, the main body 172 is configured to couple to at least one of the frame 112 or the body 114 of the refuse vehicle 100 (e.g., with fasteners, etc.). The extension body 174 is coupled to at least a portion of the lift assembly 150. For example, the extension body 174 may be coupled to the track 156 and/or the grabber assembly 152. The extension actuator 176 is configured to move the extension body 174 relative to the main body 172 to laterally extend and/or retract the grabber assembly 152 relative to the body 114. For example, the extension actuator 176 may move the extension body 174 in a first direction relative to the main body 172 to laterally extend the grabber assembly 152 from the body 114 and may move the extension body 174 in a second direction relative to the main body 172 to laterally retract the grabber assembly 152 toward the body 114. In some embodiments, the reach assembly 170 includes a plurality of extension actuators 176 configured to move the extension actuator 176 relative to the extension body 174. In some embodiments, the reach assembly 170 includes intermediate bodies slidably coupled between the extension body 174 and the main body 172. For example, an intermediate body may be slidably coupled to the main body 172 may be extended from the main body 172 a first distance to extend the grabber assembly 152 the first distance from the body 114. The extension body 174 may be slidably coupled to the intermediate body and may be extended from the intermediate body a second distance when the intermediate body extends the first distance from the main body 172 to extend the grabber assembly 152 a third distance from the body 114, the third distance equal to a sum of the first distance and the second distance.

As shown in FIGS. 5 and 6, the extension body 174 may be movably between a retracted position (e.g., a first position, etc.) and an extended position (e.g., a second position, etc.). As show FIG. 5, when the extension body 174 is in the retracted position, a distal end 178 of the extension body 174 (e.g., an end of the extension body 174 coupled to the lift assembly 150, etc.) may be positioned a first distance d₁ from the main body 172. When the extension body 174 is moved by the extension actuator 176 toward the retracted position, the extension body 174 may move the grabber assembly 152 toward the body 114. For example, when the extension body 174 is in the retracted position, the track 156 may align with an opening of the refuse compartment 130 such that when the grabber assembly 152 is transported along the track 156 toward the end of the track 156, the grabber assembly 152 may tilt and empty the contents of the refuse container in refuse compartment 130. As show FIG. 6, when the extension body 174 is in the extended position, the distal end 178 of the extension body 174 (e.g., an end of the extension body 174 coupled to the lift assembly 150, etc.) may be positioned a second distance d₂ from the main body 172, the second distance d₂ greater than the first distance d₁. When the extension body 174 is moved by the extension actuator 176 toward the extended position, the extension body 174 may move the grabber assembly 152 toward the body 114. For example, when the extension body 174 is in the extended position, the grabber assembly 152 be positioned to grasp a refuse container positioned a lateral distance from the refuse vehicle 100. The difference between the first distance d₁ and the second distance d₂ may be a maximum travel length of the extension body 174 relative to main body 172.

According to an exemplary embodiment, the reach assembly 170 is a rack-and pinion reach assembly. By way of example, the extension body 174 may include a rack (e.g., a toothed rack, a rack gear, etc.) and the extension actuator 176 may include a motor and a pinion (e.g., a pinion gear, a circular gear, etc.) that engages the rack of the extension body 174. When the motor of the extension actuator 176 drives the pinion, the engagement between the pinion and the rack of the extension body 174 moves the extension body 174 linearly relative to the extension actuator 176 and the main body 172. As a result, when the motor of the extension actuator 176 drives the pinion in a first rotational direction, the engagement between the pinion of the extension actuator 176 and the rack of the extension body 174 may move the extension body 174 toward the retracted position and when the motor of the extension actuator 176 drives the pinion in a second rotational direction (e.g., a second opposing rotational direction, etc.), the engagement between the pinion of the extension actuator 176 and the rack of the extension body 174 may move the extension body 174 toward the extended position. In other embodiments, the reach assembly 170 is a piston assembly (e.g., the extension actuator 176 is a piston that drives the extension body 174 relative to the main body 172, etc.) or another type of extension assembly (e.g., a scissor extension assembly including a scissor mechanism, a swing extension assembly that swings outward from the body 114, etc.).

### Control System

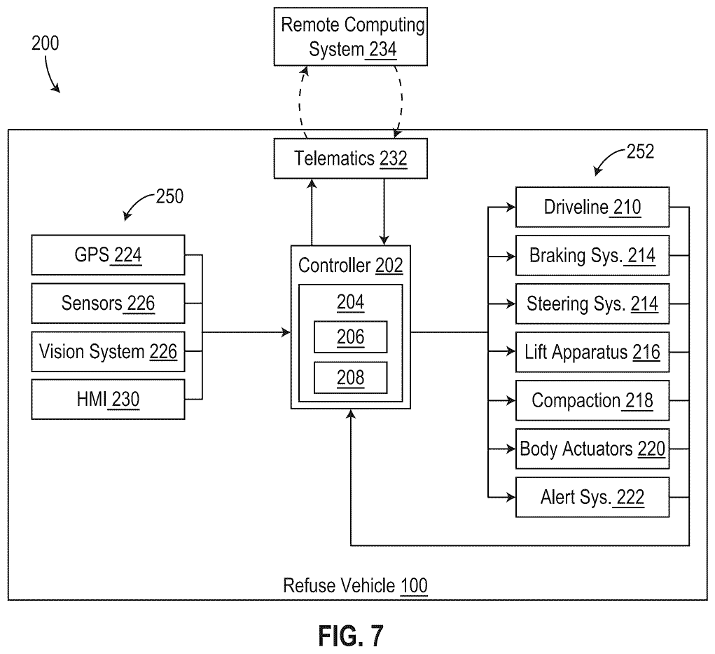

Referring to FIG. 7, the refuse vehicle 100 may include a control system 200 that is configured to facilitate autonomous or semi-autonomous operation of the refuse vehicle 100, or components thereof. The control system 200 includes a controller 202 that is positioned on the refuse vehicle 100, a remote computing system 234, a telematics unit 232, one or more input devices 250, and one or more controllable elements 252. The input devices 250 can include a Global Positioning System (“GPS”), multiple sensors 226, a vision system 228 (e.g., an awareness system), and a Human Machine Interface (“HMI”). The controllable elements 252 can include a driveline 210 of the refuse vehicle 100, a braking system 212 of the refuse vehicle 100, a steering system 214 of the refuse vehicle 100, a lift apparatus 216 (e.g., the lift assembly 140, the lift assembly 150, the reach assembly 170, etc.), a compaction system 218 (e.g., a packer assembly, the packer 146, etc.), body actuators 220 (e.g., tailgate actuators 124, lift or dumping actuators, etc.), and/or an alert system 222.

The controller 202 includes processing circuitry 204 including a processor 206 and memory 208. Processing circuitry 204 can be communicably connected with a communications interface of controller 202 such that processing circuitry 204 and the various components thereof can send and receive data via the communications interface. Processor 206 can be implemented as a general purpose processor, an application specific integrated circuit (ASIC), one or more field programmable gate arrays (FPGAs), a group of processing components, or other suitable electronic processing components.

Memory 208 (e.g., memory, memory unit, storage device, etc.) can include one or more devices (e.g., RAM, ROM, Flash memory, hard disk storage, etc.) for storing data and/or computer code for completing or facilitating the various processes, layers and modules described in the present application. Memory 208 can be or include volatile memory or non-volatile memory. Memory 208 can include database components, object code components, script components, or any other type of information structure for supporting the various activities and information structures described in the present application. According to some embodiments, memory 208 is communicably connected to processor 206 via processing circuitry 204 and includes computer code for executing (e.g., by at least one of processing circuitry 204 or processor 206) one or more processes described herein.

The controller 202 is configured to receive inputs (e.g., measurements, detections, signals, sensor data, etc.) from the input devices 250, according to some embodiments. In particular, the controller 202 may receive a GPS location from the GPS system 224 (e.g., current latitude and longitude of the refuse vehicle 100). The controller 202 may receive sensor data (e.g., engine temperature, fuel levels, transmission control unit feedback, engine control unit feedback, speed of the refuse vehicle 100, etc.) from the sensors 226. The controller 202 may receive image data (e.g., real-time camera data) from the vision system 228 of an area of the refuse vehicle 100 (e.g., in front of the refuse vehicle 100, rearwards of the refuse vehicle 100, on a street-side or curb-side of the refuse vehicle 100, at the hopper of the refuse vehicle 100 to monitor refuse that is loaded, within the cab 116 of the refuse vehicle 100, etc.). The controller 202 may receive user inputs from the HMI 230 (e.g., button presses, requests to perform a lifting or loading operation, driving operations, steering operations, braking operations, etc.).

The controller 202 may be configured to provide control outputs (e.g., control decisions, control signals, etc.) to the driveline 210 (e.g., the engine 118, the transmission 122, the engine control unit, the transmission control unit, etc.) to operate the driveline 210 to transport the refuse vehicle 100. The controller 202 may also be configured to provide control outputs to the braking system 212 to activate and operate the braking system 212 to decelerate the refuse vehicle 100 (e.g., by activating a friction brake system, a regenerative braking system, etc.). The controller 202 may be configured to provide control outputs to the steering system 214 to operate the steering system 214 to rotate or turn at least two of the tractive elements 120 to steer the refuse vehicle 100. The controller 202 may also be configured to operate actuators (e.g., motors, etc.) of the lift apparatus 216 (e.g., lift arm actuators 144, the grabber arm actuator 158, the extension actuator 176, fork actuators associated with forks of the lift assembly 140, etc.) to perform a lifting operation (e.g., to grasp, lift, empty, and return a refuse container). The controller 202 may also be configured to operate the compaction system 218 to compact or pack refuse that is within the refuse compartment 130. The controller 202 may also be configured to operate the body actuators 220 to implement a dumping operation of refuse from the refuse compartment 130 (e.g., driving the refuse compartment 130 to rotate to dump refuse at a landfill). The controller 202 may also be configured to operate the alert system 222 (e.g., lights, speakers, display screens, etc.) to provide one or more aural or visual alerts to nearby individuals.

The controller 202 may also be configured to receive feedback from any of the driveline 210, the braking system 212, the steering system 214, the lift apparatus 216, the compaction system 218, the body actuators 220, or the alert system 222. The controller 202 may provide any of the feedback to the remote computing system 234 via the telematics unit 232. The telematics unit 232 may include any wireless transceiver, cellular dongle, communications radios, antennas, etc., to establish wireless communication with the remote computing system 234. The telematics unit 232 may facilitate communications with telematics units 232 of nearby refuse vehicles 100 to thereby establish a mesh network of refuse vehicles 100.

The controller 202 is configured to use any of the inputs from any of the GPS system 224, the sensors 226, the vision system 228, or the HMI 230 to generate controls for the driveline 210, the braking system 212, the steering system 214, the lift apparatus 216, the compaction system 218, the body actuators 220, or the alert system 222. In some embodiments, the controller 202 is configured to operate the driveline 210, the braking system 212, the steering system 214, the lift apparatus 216, the compaction system 218, the body actuators 220, and/or the alert system 222 to autonomously transport the refuse vehicle 100 along a route (e.g., self-driving), perform pickups or refuse collection operations autonomously, and transport to a landfill to empty contents of the refuse compartment 130. The controller 202 may receive one or more inputs from the remote computing system 234 such as route data, indications of pickup locations along the route, route updates, customer information, pickup types, etc. The controller 202 may use the inputs from the remote computing system 234 to autonomously transport the refuse vehicle 100 along the route and/or to perform the various operations along the route (e.g., picking up and emptying refuse containers, providing alerts to nearby individuals, limiting pickup operations until an individual has moved out of the way, etc.).

In some embodiments, the remote computing system 234 is configured to interact with (e.g., control, monitor, etc.) the refuse vehicle 100 through a virtual refuse truck as described in U.S. application Ser. No. 16/789,962, now U.S. Pat. No. 11,380,145, filed Feb. 13, 2020, the entire disclosure of which is incorporated by reference herein. The remote computing system 234 may perform any of the route planning techniques as described in greater detail in U.S. application Ser. No. 18/111,137, filed Feb. 17, 2023, the entire disclosure of which is incorporated by reference herein. The remote computing system 234 may implement any route planning techniques based on data received by the controller 202. In some embodiments, the controller 202 is configured to implement any of the cart alignment techniques as described in U.S. application Ser. No. 18/242,224, filed Sep. 5, 2023, the entire disclosure of which is incorporated by reference herein. The refuse vehicle 100 and the remote computing system 234 may also operate or implement geofences as described in greater detail in U.S. application Ser. No. 17/232,855, filed Apr. 16, 2021, the entire disclosure of which is incorporated by reference herein.

### Position Based Control

According to an exemplary embodiment, the controller 202 is configured to derate (e.g., slow down, limit, etc.) a speed of at least one actuator of the lift apparatus 216 based on positions associated with the lift apparatus 216. For example, when the controller 202 is operating the actuator of the lift apparatus 216 to perform a lifting operation, the controller 202 may operate an actuator of the lift apparatus 216 at a first speed to drive a movable body. However, when a position associated with the movable body of the lift apparatus 216 reaches a derating positional range (e.g., being greater than a positional threshold, being less than a positional threshold, etc.) associated with the movable body, the controller 202 may operate the actuator of the lift apparatus 216 at a second speed (e.g., a derated speed, etc.) that is slower than the first speed. In some embodiments, the controller 202 may reduce (e.g., continuously or semi-continuously) the speed of the lift apparatus 216 as a function of position over a threshold range of positions as the lift apparatus 216 approaches an end stop. As a result, an operating speed of the lift apparatus 216 may be decreased when as the lift apparatus 216 approaches certain orientations where a slower operating speed may be desired. For example, the controller 202 may derate the speed of the extension actuator 176 of the reach assembly 170 when the extension body 174 is approaching the retracted position. By operating the extension actuator 176 at a derated speed, the extension body 174 may reach the retracted position while traveling at a lower speed than if the extension actuator 176 was being operated at a maximum operating speed, which may result in a lower change in momentum of the extension body 174 and/or the grabber assembly 152 when the extension body 174 reaches the retracted position. As a result, a force applied by the extension body 174 on an end stop of the reach assembly 170 (e.g., a hard stop, etc.) may be reduced, increasing an operational lifespan of the reach assembly 170 (e.g., by reducing fatigue in the reach assembly 170, by preventing wear on the extension actuator 176 etc.) and/or increasing an accuracy of the operation of the reach assembly 170 (e.g., by reducing a likelihood of faults in the sensor data received from the sensors 226, by preventing the extension actuator 176 from drifting, etc.). Additionally or alternatively, a jostling (e.g., movement, etc.) of a refuse container grasped by the grabber assembly 152 may be reduced, which may prevent refuse contained within the refuse container from being dumped out of the refuse container and/or prevent the grabber assembly 152 from releasing the refuse container.

In some embodiments, the controller 202 is configured to derate the speed of the at least one actuator of the lift apparatus 216 when an operator is operating the lift apparatus 216. By way of example, the controller 202 may receive user inputs from the HMI 230 associated with operating the lift apparatus 216 and the controller 202 may derate the speed of the at least one actuator of the lift apparatus 216 while operating the lift apparatus 216 according to the user inputs. In some embodiments, the controller 202 is configured to derate the speed of the at least one actuator of the lift apparatus 216 during autonomous or semi-autonomous operation of the lift apparatus 216. For example, the controller 202 may be configured to autonomously operate the lift apparatus 216 through the lifting operation (e.g., to grasp, lift, empty, and return a refuse container) and the controller 202 may derate the speed of the at least one actuator of the lift apparatus 216 while operating the lift apparatus 216 through the lifting operation.

In some embodiments, the controller 202 is configured to derate the speed of the at least one actuator of the lift apparatus 216 when speed derating is enabled. When the speed derating is enabled, the controller 202 may be allowed to derate the speed of the at least one actuator of the lift apparatus 216. When the speed derating is disabled, the controller 202 may be prohibited from derating the speed of the at least one actuator of the lift apparatus 216. By way of example, the HMI 230 may include a derate interface (e.g., a button, a switch, etc.) associated with derating the speed of the at least one actuator of the lift apparatus 216. The HMI 230 may provide a user input to the controller 202 based on operator interactions with the derate interface that correspond with enabling or disabling derating the speed of the at least one actuator of the lift apparatus 216 to allow or prohibit the controller 202 from derating the speed of the at least one actuator of the lift apparatus 216. By way of another example, the controller 202 may be configured to enable or disable the speed derating based on whether the lift apparatus 216 is engage with a refuse container. The controller 202 may determine whether the lift apparatus 216 is engaging a refuse container based on the sensor data received from the sensors 226. When the lift apparatus 216 is engaging the refuse container, the controller 202 may enable the speed derating. When the lift apparatus 216 is not engaging the refuse container, the controller 202 may disable the speed derating.

In some embodiments, the controller 202 is configured to derate the speed of the actuators of the lift apparatus 216 based on positional data corresponding to positions of the moveable bodies of the lift apparatus 216 received from at least one of the sensors 226. For example, the controller 202 may operate a first of the actuators of the lift apparatus 216 at a maximum operating speed, receive positional data from at least one of the sensors 226 corresponding to a position associated with a movable body of the lift apparatus 216, and, responsive to the position associated with the movable body being within a derating positional range, operate the first of the actuators of the lift apparatus 216 at a derated operating speed that is slower than the maximum operating speed. In various embodiments, the controller 202 is configured to derate a speed of other actuators of the refuse vehicle 100 (e.g., actuators of the driveline 210, actuators of the steering system 214, actuators of the compaction system 218, the body actuators, etc.). For example, the controller 202 may derate the speed of the other actuators of the refuse vehicle 100 based on positions of movable bodies of the refuse vehicle 100 being within derating positional ranges. The controller 202 may determine that the positions of the movable bodies of the refuse vehicle 100 are within the derating positional ranges based on position data acquired from the sensors 226 of the refuse vehicle 100 corresponding to the positions of the movable bodies of the refuse vehicle 100.

As shown in FIGS. 5 and 6, the control system 200 includes a reach position component 260 (e.g., a reach position sensor, a reach position inverter, etc.) configured to generate position data corresponding to a position associated with the extension body 174. For example, the reach position component 260 may be configured to generate positional data corresponding to a position of the extension body 174 relative to the main body 172 (e.g., the distance of the distal end 178 of the extension body 174 from the main body 172, etc.). As another example, the reach position component 260 may be configured to generate positional data corresponding to a position of a portion of the lift assembly 150 relative to the main body 172, which may be associated with the position of the extension body 174 since the lift assembly 150 may be coupled to the distal end 178 of the extension body 174.

According to the exemplary embodiment shown in FIGS. 5 and 6, the reach position component 260 is at least one of the sensors 226 configured as an encoder (e.g., a rotational sensor, etc.) configured to generate position data corresponding to the position of the extension body 174 based on operation of the extension actuator 176. By way of example, when the extension actuator 176 is a motor, the reach position component 260 may be a rotational encoder that is rotated as the extension actuator 176 rotates to drive (e.g., move, etc.) the extension body 174 between the extended position and the retracted position. The reach position component 260 may count a number of rotations of the extension actuator 176 and generate the position data corresponding to the position of the extension body 174 based on the number of rotations. By way of another example, when the extension actuator 176 is configured as a linear actuator, the reach position component 260 may be a linear encoder that measures actuation distances of the extension actuator 176 as the extension actuator 176 actuates to drive the extension body 174 between the extended position and the retracted position. The reach position component 260 may determine the actuation distance of the extension actuator 176 and generate the position data corresponding to the position of the extension body 174 based on the actuation distance of the extension actuator 176. In other embodiments, the reach position component 260 is another type of sensor configured to generate position data corresponding to the position of the extension body 174. By way of example, the reach position component 260 may be a distance sensor (e.g., an ultrasonic sensor, an infrared sensor, a camera, etc.) configured to generate the position data corresponding to the position of the extension body 174 based on a distance between the reach position component 260 and a portion of the extension body 174 (e.g., the distal end 178 of the extension body 174, etc.) and/or a portion of the lift assembly 150 (e.g., the grabber assembly 152, the track 156, etc.). By way of another example, the reach position component 260 may be an inverter configured to operate the extension actuator 176 (e.g., electrically coupled between a battery and/or an energy storage system of the refuse vehicle 100 and the extension actuator 176, etc.) and to generate the position data corresponding to the position of the extension body 174 based on measured voltages and/or currents provided to the extension actuator 176 (e.g., back electro-magnetic forces from the extension actuator 176, characteristics of electrical energy provided to the extension actuator 176 by the inverter, etc.).

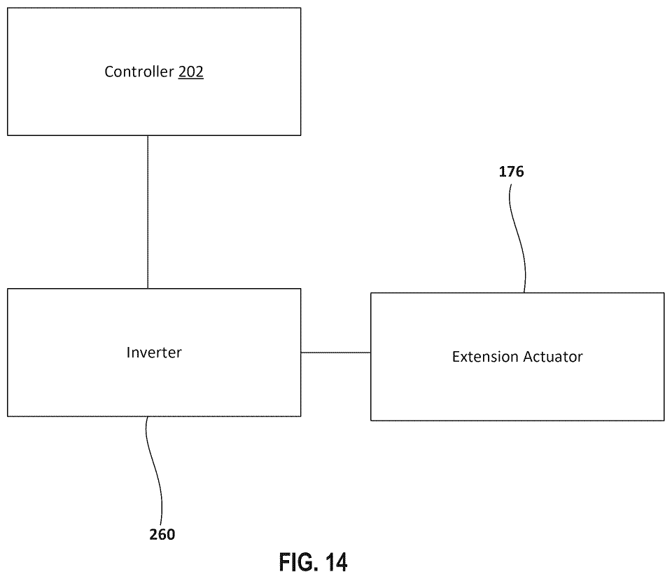

According to the exemplary embodiment shown in FIG. 14, the reach position component 260 is an inverter configured to (i) drive the extension actuator 176 based on control signals received from the controller 202 and (ii) generate position data corresponding to the position of the extension body 174 based on electronic feedback (e.g., back electromotive forces, back voltages, etc.) associated with driving the extension actuator 176. By way of example, when the extension actuator 176 is an electric motor, the reach position component 260 may be an inverter configured to drive the extension actuator by providing a current to the extension actuator 176. The reach position component 260 may generate the position data corresponding to the position of the extension body 174 based on a back voltage in the extension actuator 176 that is caused by the current provided by the reach position component 260 to the extension actuator 176. By way of another example, the reach position component 260 may be an inverter configured to generate the position data corresponding to the position of the extension body 174 based on voltage and current measurements on conductors within the inverter that are utilized to power the extension actuator 176. By configuring the reach position component 260 as the inverter configured to generate the position data, the control system 200 may generate the position data without utilizing one of the sensors 226 (e.g., generate the position data sensorlessly, the reach position component 260 is sensorless, sensorless invertor position feedback, etc.).

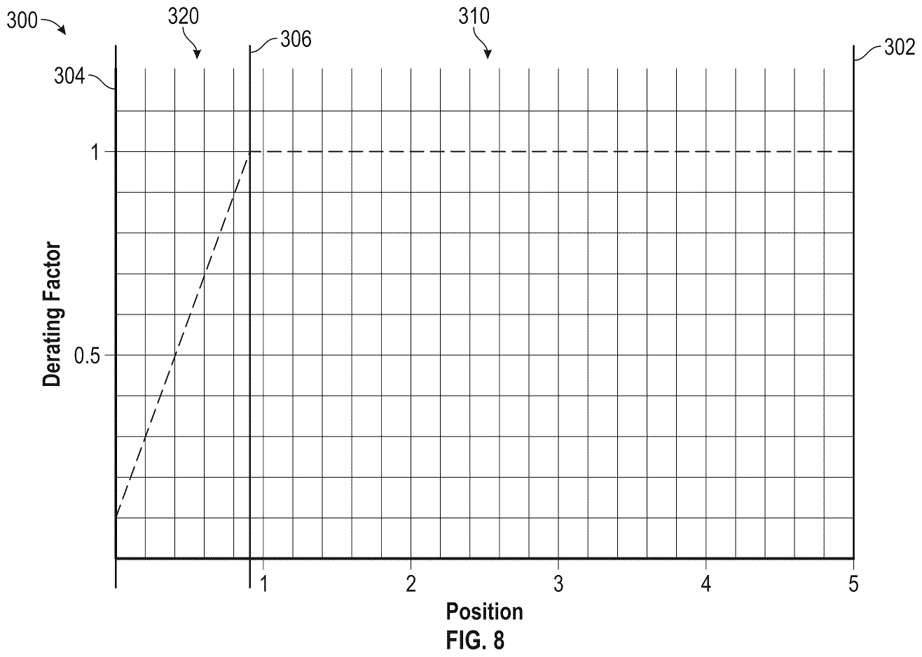

As shown in FIG. 8, the controller 202 is configured to derate the speed of an actuator (e.g., the lift arm actuators 144, the extension actuator 176, the grabber arm actuator 158, the fork actuators associated with the forks of the lift assembly 140, etc.) of the refuse vehicle 100 according to an actuator derating chart 300 (e.g., first derating chart, etc.) based on a position of a movable body of the refuse vehicle 100 driven by the actuator (e.g., the lift arms 142 for the lift arm actuators 144, the extension body 174 for the extension actuator 176, the grabber arm actuator 158 for the grabber arms 154, the fork actuators for forks of the lift assembly 140, etc.). The actuator derating chart 300 depicts a derating factor associated with the speed of the actuator versus a position of the movable body. As shown in FIG. 8, the actuator derating chart 300 includes a first end position 302 corresponding to a first end position of the movable body (e.g., a maximum position, etc.), a second end position 304 corresponding to a second end position of the movable body (e.g., a minimum position, etc.), and a derating position threshold 306 corresponding to a threshold where the controller 202 begins derating the actuator as the actuator drives the movable body in a first direction from the first end position 302 toward the second end position 304. The first end position 302 and the derating position threshold 306 define a non-derating range 310 (e.g., a first range, etc.) and the derating position threshold 306 and the second end position 304 define a derating range 320 (e.g., a second range, etc.). The controller 202 is configured to operate the actuator at a speed equal to a normal operating speed (e.g., a maximum speed, an operating speed, etc.) of the actuator multiplied by the derating factor corresponding to the position of the movable body driven by the actuator. For example, when position data corresponding to a position the movable body indicates that the position of the movable body is in the non-derating range 310 and the actuator is driving the movable body in the first direction, the controller 202 is configured to operate the actuator with a first speed equal to the normal operating speed multiplied by the derating factor of 1 such that the first speed is equal to the normal operating speed. When the position data corresponding to the position the movable body indicates that the position of the movable body is in the derating range 320 and the actuator is driving the movable body in the first direction, the controller 202 is configured to operate the actuator with a derated second speed that is equal to the normal operating speed multiplied by the derating factor corresponding to the position of the movable body. As a result, the actuator is being operating at a speed lower than the normal operating speed of the actuator when the movable body reaches the second end position 304.

According to the exemplary embodiment shown in FIG. 8, the derating factor of the actuator derating chart 300 linearly decreases from the derating position threshold 306 toward the second end position 304. By way of example, the derating factor may decrease from a first derating factor of 1 at the derating position threshold 306 toward a second derating factor of 0.1 at the second end position 304 such that the controller 202 derates the speed of the actuator at a linear rate as the position of the movable body approaches the second end position 304. In other embodiments, the derating factor of the actuator derating chart 300 decreases at a non-linear rate from the derating position threshold 306 to the second end position 304.

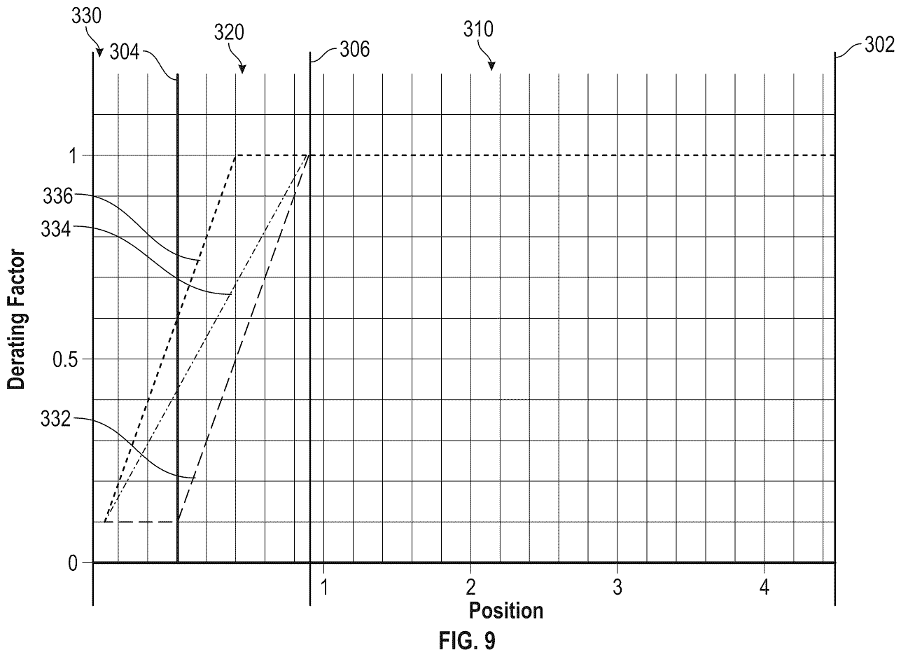

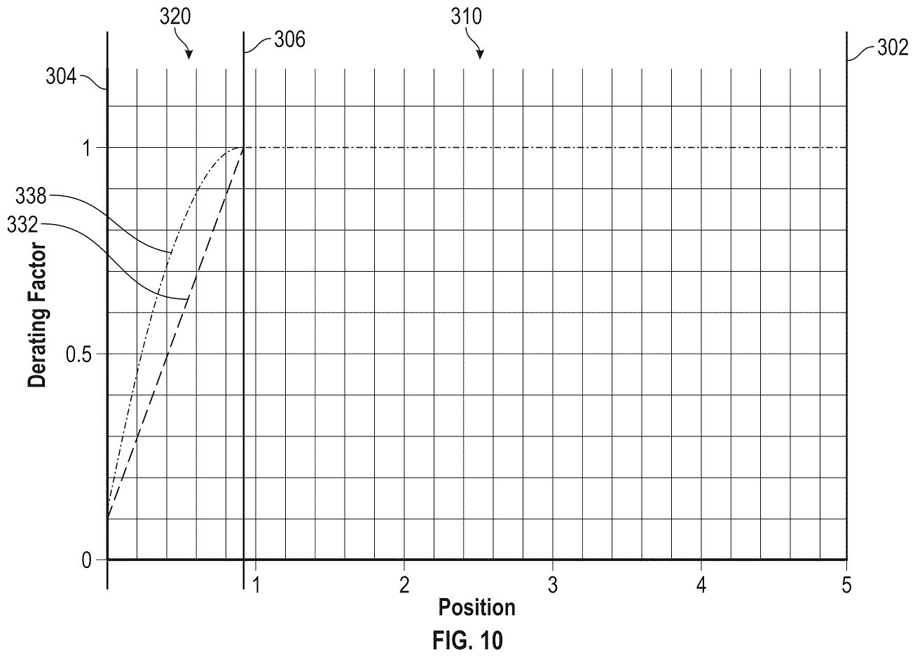

As shown in FIGS. 9 and 10, the actuator derating chart 300 includes an overshot range 330 extending from the second end position 304 in the direction from the first end position 302 towards the second end position 304. The overshot range 330 may represent a condition when the actuator drives the movable body past the second end position 304 into a position that is outside of a normal operating range (e.g., a range between the first end position 302 and the second end position 304, etc.) of the movable body. Similar to the non-derating range 310 and the derating range 320, when the movable body is positioned within the overshot range 330 the controller 202 is configured to operate the actuator at a speed equal to the normal operating speed of the actuator multiplied by the derating factor corresponding to the position of the movable body driven by the actuator. For example, when the movable body is positioned within the overshot range 330, the controller 202 may operate the actuator to drive the movable body toward the second end position 304 such that the movable body is no longer positioned within the overshot range 330. However, if the derating factor associated with the position of the movable body being in the overshot range 330 is low, the actuator may be operated at a low speed when driving the movable body out of the overshot range 330, which may result in a substantial amount of time before the movable body is removed from the overshot range 330. In some embodiments, the controller 202 utilizes the actuator derating chart 300 with the overshot range 330 after determining that the position of the movable body is within the overshot range 330.

As shown in FIG. 9, the actuator derating chart 300 includes a first derating factor line 332, a second derating factor line 334, and a third derating factor line 336. The first derating factor line 332 extends linearly downward from the derating position threshold 306 toward the second end position 304 and then is constant through the overshot range 330. The second derating factor line 334 extends linearly downward from the derating position threshold 306 toward the second end position 304 and into the overshot range 330 such that a decrease in the derating factor is constant through the derating range 320 and the overshot range 330. The third derating factor line 336 extends at a constant from the derating position threshold 306 toward the second end position 304 and then extends linearly downward through the derating range 320 and into the overshot range 330. According to the exemplary embodiment shown in FIG. 9, the portions of the first derating factor line 332 and the third derating factor line 336 that extend linearly downward extend at a first slope (e.g., a first rate, etc.) and the second derating factor line 334 extends linearly downward at a second slope (e.g., a second rate, etc.) that is shallower (e.g., less, etc.) than the first slope. If the controller 202 operates the actuator according to the first derating factor line 332, the low value of the derating factor through the overshot range 330 comparted to the second derating factor line 334 and the third derating factor line 336 may result in a substantial delay when the actuator drives the movable body out of the overshot range 330. As a result, the controller 202 may utilize the second derating factor line 334 or the third derating factor line 336 when operating the actuator to drive the movable body out of the overshot range 330. In some embodiments, the controller 202 utilizes the third derating factor line 336 instead of the second derating factor line 334 when operating the actuator to drive the movable body out of the overshot range 330 because the third derating factor line 336 may cause the movable body to exit the overshot range 330 more rapidly than the second derating factor line 334.

According to the exemplary embodiment shown in FIG. 10, the derating factor of the actuator derating chart 300 includes the first derating factor line 332 that linearly decreased from the derating position threshold 306 toward the second end position 304 and a fourth derating factor line 338 that non-linearly decreases from the derating position threshold 306 toward the second end position 304. For example, the fourth derating factor line 338 may decrease at an increasing rate from the derating position threshold 306 to the second end position 304 such that the decrease in the derating factor is less noticeable to an operator of the refuse vehicle 100 when the movable body reaches the derating position threshold 306 and enters the derating range 320. As another example, the fourth derating factor line 338 may decrease at a decreasing rate from the derating position threshold 306 to the second end position 304 such that a rate of decrease of the derating factor decreases as the movable body approaches the second end position 304.

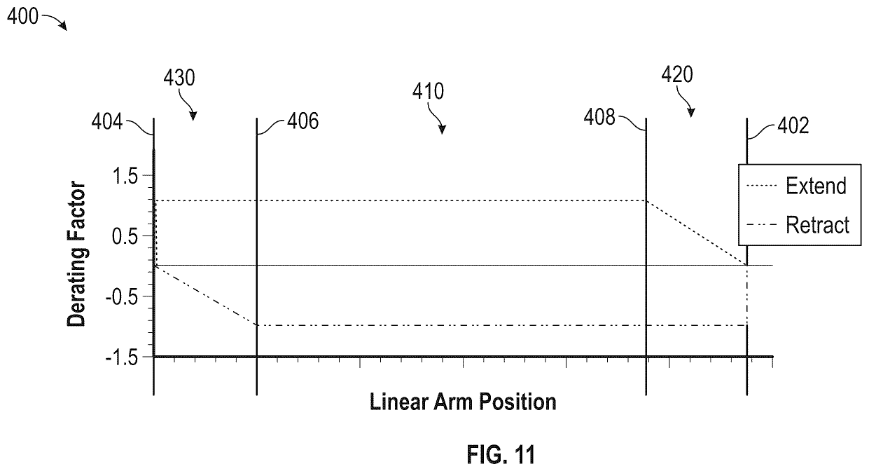

As shown in FIG. 11, the controller 202 is configured to derate the speed of the extension actuator 176 according to a reach assembly derating chart 400. The reach assembly derating chart 400 depicts a derating factor associated with the speed of the extension actuator 176 versus a position of the extension body 174 when the extension actuator 176 is driving the extension body 174 between the retracted position and the extended position. On the reach assembly derating chart 400, the derating factor is positive (e.g., ranging from 0 to 1, etc.) when the extension actuator 176 is driving the extension body 174 toward the extended position and negative (e.g., ranging from 0 to −1, etc.) when the extension actuator 176 is driving the extension body 174 toward the retracted position. As shown in FIG. 10, the reach assembly derating chart 400 includes an extended position 402 corresponding to the extended position of the extension body 174, a retracted position 404 corresponding to the retracted position of the extension body 174, a retraction derating position threshold 406 (e.g., a first derating position threshold, etc.) corresponding to a first threshold where the controller 202 begins derating the extension actuator 176 as the extension actuator 176 drives the extension body 174 toward the retracted position 404 (e.g., drives the extension body 174 in the retracting direction, etc.), and an extension derating position threshold 408 (e.g., a second derating position threshold, etc.) corresponding to a second threshold where the controller 202 begins derating the extension actuator 176 as the extension actuator 176 drives the extension body 174 toward the extended position 402 (e.g., drives the extension body 174 in the extending direction, etc.).

The retraction derating position threshold 406 and the extension derating position threshold 408 define a non-derating range 410 (e.g., a first range, etc.), the extended position 402 and the extension derating position threshold 408 define an extension derating range 420 (e.g., a second range, a first derating range, etc.), and the retraction derating position threshold 406 and the retracted position 404 define a retraction derating range 430 (e.g., a third range, a second derating range, etc.). The controller 202 is configured to operate the extension actuator 176 at a speed equal to a normal operating speed (e.g., a maximum speed, an operating speed, etc.) of the extension actuator 176 multiplied by the derating factor corresponding to the position of the extension body 174 and a direction that the extension actuator 176 is driving the extension body 174. For example, when the position data corresponding to the position of the extension body 174 indicates that the position of the extension body 174 is within the retraction derating range 430 or the non-derating range 410 and the extension actuator 176 is driving the extension body 174 toward the extended position 402, the controller 202 is configured to operate the extension actuator 176 with a first speed equal to the normal operating speed multiplied by the derating factor of 1 such that the first speed is equal to the normal operating speed in a direction toward the extended position 402. When the position data corresponding to the position of the extension body 174 indicates that the position of the extension body 174 is within the extension derating range 420 and the extension actuator 176 is driving the extension body 174 toward the extended position 402, the controller 202 is configured to operate the extension actuator 176 with a second derated speed equal to the normal operating speed multiplied by the derating factor corresponding to the position of the extension body 174 in the direction toward the extended position 402. As a result, the extension actuator 176 is operated at a speed lower than the normal operating speed of the extension actuator 176 when the position of the extension body 174 is within the extension derating range 420 and the extension actuator 176 is driving the extension body 174 toward the extended position 402. In some embodiments, when the extension actuator 176 is driving the extension body 174 toward the extended position 402 and the position data corresponding to the position of the extension body 174 indicates that the position of the extension body 174 is at the extended position 402, the derating factor is equal to zero.

As another example, when the position data corresponding to the position of the extension body 174 indicates that the position of the extension body 174 is within the extension derating range 420 or the non-derating range 410 and the extension actuator 176 is driving the extension body 174 toward the retracted position 404, the controller 202 is configured to operate the extension actuator 176 with a third speed equal to the normal operating speed multiplied by the derating factor of −1 such that the third speed is equal to the normal operating speed in a direction toward the retracted position 404. When the position data corresponding to the position of the extension body 174 indicates that the extension body 174 is within the retraction derating range 430 and the extension actuator 176 is driving the extension body 174 toward the retracted position 404, the controller 202 is configured to operate the extension actuator 176 with a fourth derated speed equal to the normal operating speed multiplied by the derating factor corresponding to the position of the extension body 174 in the direction toward the retracted position 404. As a result, the extension actuator 176 is operated at a speed lower than the normal operating speed of the extension actuator 176 when the position of the extension body 174 is within the retraction derating range 430 and the extension actuator 176 is driving the extension body 174 toward the retracted position 404. In some embodiments, when the extension actuator 176 is driving the extension body 174 toward the retracted position 404 and the position data corresponding to the position of the extension body 174 indicates that the extension body 174 is at the retracted position 404, the derating factor is equal to zero.

According the exemplary embodiment shown in FIG. 10, the derating factor of the reach assembly derating chart 400 corresponding to the extension actuator 176 driving the extension body 174 toward the extended position 402 linearly decreases from the extension derating position threshold 408 to the extended position 402 and the derating factor of the reach assembly derating chart 400 corresponding to the extension actuator 176 driving the extension body 174 toward the retracted position 404 linearly increases (e.g., from −1 towards 0, a magnitude of the derating factor decreases, etc.) from the retraction derating position threshold 406 to the retracted position 404. For example, the derating factor corresponding to the extension actuator 176 driving the extension body 174 toward the extended position 402 may linearly decrease from a first derating factor of 1 at the extension derating position threshold 408 toward a second derating factor of 0.1 at the extended position 402 such that the controller 202 derates the speed of the extension actuator 176 at a linear rate as the position of the extension body 174 approaches the extended position 402. For another example, the derating factor corresponding to the extension actuator 176 driving the extension body 174 toward the retracted position 404 may linearly increase from a first derating factor of −1 at the retraction derating position threshold 406 toward a second derating factor of −0.1 at the retracted position 404 such that the controller 202 derates the speed of the extension actuator 176 at a linear rate as the position of the extension body 174 approaches the extended position 402. In other embodiments, the derating factor of the reach assembly derating chart 400 corresponding to the extension actuator 176 driving the extension body 174 toward the extended position 402 decreases non-linearly from the extension derating position threshold 408 to the extended position 402 and/or the derating factor of the reach assembly derating chart 400 corresponding to the extension actuator 176 driving the extension body 174 toward the retracted position 404 increases non-linearly from the retraction derating position threshold 406 to the retracted position 404.

In some embodiments, the reach assembly derating chart 400 includes first overshot range extending from the retracted position 404 in a first direction from the extended position 402 toward the retracted position 404 and/or a second overshot range extending from the extended position 402 in a second direction from the retracted position 404 toward the extended position 402. The first overshot range may represent a condition when the extension actuator 176 drives the position of the extension body 174 past the retracted position 404 to a position that is outside of a normal operating range. For example, the first overshot range may include positive derating factor associated with when the extension actuator 176 is driving the extension body 174 toward the extended position 402 to allow for the controller 202 to operate the extension actuator 176 to drive the extension body 174 out of the first overshot range and into the retraction derating range 430. The second overshot range may represent a condition when the extension actuator 176 drives the position of the extension body 174 past the extended position 402 to a position that is outside of the normal operating range. For example, the second overshot range may include a negative derating factor associated with when the extension actuator 176 is driving the extension body 174 toward the retracted position 404 to allow for the controller 202 to operate the extension actuator 176 to drive the extension body 174 out of the second overshot range and into the extension derating range 420. Similar to the non-derating range 410, the extension derating range 420, and the retraction derating range 430, when the position of the extension body 174 is within the first overshot range and/or the second overshot range, the controller 202 is configured to operate the extension actuator 176 at a speed equal to the normal operating speed of the extension actuator 176 multiplied by the derating factor corresponding to the position of the extension body 174. The derating factor in the first overshot range and/or the second overshot range may be arranged similar to any one of the first derating factor line 332, the second derating factor line 334, the third derating factor line 336, or the fourth derating factor line 338 in the actuator derating chart 300.

In some embodiments, the controller 202 is configured to derate the speed of the extension actuator 176 by multiplying the normal operating speed of the extension actuator 176 by a derating factor based on sensor data corresponding to the refuse vehicle 100 received from other of the sensors 226 (e.g., other than the reach position component 260 when the reach position component 260 is configured as at least one of the sensors 266, etc.). The controller 202 may derate the speed of the extension actuator 176 based on sensor data corresponding to the driveline 210, the braking system 212, the steering system 214, the lift apparatus 216, the compaction system 218, the body actuators 220, or the alert system 222. For example, the sensor data received from the sensors 226 may correspond to a travel distance of the grabber assembly 152 along the track 156 from a bottom position of the grabber assembly 152 along the track 156. When the sensor data indicates that the travel distance of the grabber assembly 152 along the track 156 is above a distance threshold (e.g., the grabber assembly 152 is in a raised position on the track 156, etc.), the controller 202 may derate the speed of the extension actuator 176 by multiplying the normal operating speed of the extension actuator 176 by a small derating factor such that the controller 202 operates the extension actuator 176 at a speed slower than the normal operating speed. The controller 202 may derate the speed of the extension actuator 176 when the travel distance of the grabber assembly 152 along the track 156 is above the distance threshold to prevent a refuse container grasped by the grabber assembly 152 from spilling refuse when the grabber assembly 152 is in an elevated position, which may occur if the extension actuator 176 is operated at the normal operating speed.

As shown in FIG. 12, at least one of the sensors 226 is configured as a distance sensor 262 configured to generate distance data corresponding to a distance between the grabber assembly 152 and an object. For example, the distance sensor 262 may be a LIDAR sensor (e.g., a perception sensor, etc.) configured to generate distance data (e.g., perception data corresponding to the refuse container, etc.) corresponding to a distance between the grabber assembly 152 and a refuse container such that the controller 202 may determine the distance between the grabber assembly 152 and the refuse container in order to operate the lift apparatus 216 to engage the refuse container with the grabber assembly 152. As another example, the distance sensor 262 may be a stereo camera that includes a first camera lens configured to generate first image data and a second camera lens configured to generate second image data. Collectively, the first image data and the second image data may be distance data corresponding to the distance between the grabber assembly 152 and a refuse container due to a parallax (e.g., a difference due to offset, etc.) between the first image data and the second image data, as the controller 202 may determine the distance between the grabber assembly 152 and the refuse container based on the parallax. According to the exemplary embodiment shown in FIG. 12, the distance sensor 262 is coupled to (e.g., positioned on, etc.) the grabber assembly 152. In other embodiments, the distance sensor 262 is otherwise positioned on the refuse vehicle 100.

According to an exemplary embodiment, the controller 202 is configured to determine a desired extended position of the extension body 174 based on the distance data received from the distance sensor 262. By way of example, the controller 202 may receive the distance data corresponding to a distance between the grabber assembly 152 and a refuse container and may determine the desired extended position of the extension body 174 based on a position of the extension body 174 that would cause the grabber assembly 152 to be able to engage (e.g., grasp, etc.) the refuse container. The controller 202 may be configured to derate the speed of the extension actuator 176 based on the desired extended position of the extension body 174 to prevent the grabber assembly 152 from contacting the grabber assembly 152 while the extension actuator 176 is being operated at the normal operating speed, which may cause the grabber assembly 152 to push the refuse container away from the refuse vehicle 100. For example, the controller 202 may derate the speed of the extension actuator 176 according to the reach assembly derating chart 400 based on the distance data received from the distance sensor 262 corresponding to the distance between the grabber assembly 152 and the refuse container by setting the extended position 402 equal to the desired extended position of the extension body 174. As a result, as the extension actuator 176 drives the extension body 174 to move the grabber assembly 152 toward the refuse container, the controller 202 will derate the speed of the extension actuator 176 when the position of the extension actuator 176 enters the extension derating range 420 prior to the extension actuator 176 reaching the desired extended position to prevent the grabber assembly 152 from contacting the refuse container while traveling at full speed.

In some embodiments, the controller 202 is configured to determine the desired extended position of the extension body 174 based on the distance data received from the distance sensor 262 and derate the speed of the extension actuator 176 based on the desired extended position of the extension body 174 when the extension actuator 176 is driving the extension body 174 in the extending direction from the retracted position 404 toward the extended position 402. By way of example, the controller 202 may derate the speed of the extension actuator 176 based on the desired extended position when the extension actuator 176 is driving the extension body 174 toward the extended position 402. When the extension actuator 176 is driving the extension body 174 toward the retracted position 404, the controller 202 may still derate the speed of the extension actuator 176 based on the retracted position 404.

In some examples, the controller 202 is configured to determine the desired extended position of the extension body 174 based on the distance data received from the distance sensor 262 and derate the speed of the extension actuator 176 based on the desired extended position of the extension body 174 when the controller 202 determines that the grabber assembly 152 is not grasping a refuse container. For example, the controller 202 may derate the speed of the extension actuator 176 based on the desired extended position when the grabber arms 154 are in the disengaged state. When the grabber arms 154 are in the engaged state, the controller 202 may still derate the speed of the extension actuator 176 based on the extended position 402.

In some embodiments, the controller 202 is configured to determine the desired extended position of the extension body 174 based on the distance data received from the distance sensor 262 and derate the speed of the extension actuator 176 based on the desired extended position of the extension body 174 when derating the speed based on the distance data is enabled. When derating the speed based the distance data is enabled, the controller 202 may be allowed to derate the speed of the extension actuator 176 based on the desired extended position of the extension body 174. When derating the speed based on the distance data is disabled, the controller 202 may be prohibited from derating the speed of the extension actuator 176 based on the desired extended position of the extension body 174 (e.g., may be required to derate the speed of the extension actuator 176 based on a maximum extended position of the extension body 174, etc.). By way of example, the HMI 230 may include a distance derate interface (e.g., a button, a switch, etc.) associated with derating the speed of the extension actuator 176 based on the desired extended position. The HMI 230 may provide a user input to the controller 202 based on operator interactions with the derate interface that correspond with enabling or disabling derating the speed of the extension actuator 176 based on the desired extended position.

In some embodiments, the controller 202 is configured to determine the desired extended position of the extension body 174 based on the distance data received from the distance sensor 262 and derate the speed of the extension actuator 176 based on the desired extended position of the extension body 174 when an operator is operating the lift apparatus 216. By way of example, the controller 202 may receive user inputs from the HMI 230 associated with operating the lift apparatus 216 and the controller 202 may derate the speed of the extension actuator 176 based on the desired extended position of the extension body 174 while operating the lift apparatus 216 according to the user inputs. In some embodiments, when the operator is operating the lift apparatus 216 and the extended position 402 corresponds to the desired extended position, the derating factor at the extended position 402 may be greater than zero such that the operator may continue to operate the extension actuator 176 to extend the extension body 174 past the extended position 402. For example, when the extension actuator 176 reaches the extended position 402, the controller 202 may derate the speed of the extension actuator 176 such that the extension actuator 176 slows down but does not stop. In some embodiments, the controller 202 is configured to determine the desired extended position of the extension body 174 based on the distance data received from the distance sensor 262 and derate the speed of the extension actuator 176 based on the desired extended position of the extension body 174 during autonomous or semi-autonomous operation of the lift apparatus 216.

In some embodiments, the controller 202 is configured to determine desired extended positions and/or desired retracted positions of the extension body 174 based on other functions of the refuse vehicle 100. By way of example, when operating the lift apparatus 216 to retrieve a refuse container, the controller 202 may determine a position of the extension body 174 when the grabber assembly 152 grasps a refuse container. The controller 202 may determine that the position of the extension body 174 when the grabber assembly 152 grasped the refuse container is the desired extended position such that the controller 202 can derate the speed of the extension actuator 176 based on the desired extended position of the extension body 174 to ensure that the grabber assembly 152 releases the refuse container at a same location that the grabber assembly 152 grasped the refuse container. By way of another example, the controller 202 may determine the desired extended positions and/or desired retracted positions based on operational presets of the refuse vehicle 100 that correspond with desired positions of the extension body 174 (e.g., a home operational preset that positions the extension body 174 in a home position, a stowed operational preset that positions the extension body 174 in a stowed position, specific grab position operational presets that position the extension body 174 in specific positions to place the grabber assembly 152 in specific grab positions, etc.). The controller 202 may be configured to derate the speed of the extension actuator 176 based on the desired extended positions and/or the desired retracted positions of the extension body 174. For example, the controller 202 may derate the speed of the extension actuator 176 according to the reach assembly derating chart 400 by setting the extended position 402 equal to the desired extended position of the extension body 174 and/or setting the retracted position 404 equal to the desired retracted position of the extension body 174.

In some embodiments, the controller 202 is configured to calibrate (e.g., zero, etc.) the position data received from the reach position component 260 to correspond with the retracted position of the extension body 174 based on an indication that the extension body 174 is in the retracted position. For example, the controller 202 may assign the position of the extension body 174 (e.g., a current position of the extension body 174, etc.) as the retracted position of the extension body 174 based on the indication that the extension body 174 is in the retracted position. By zeroing the position data to correspond with the retracted position of the extension body 174 when receiving the indication that the extension body 174 is in the retracted position may allow for the controller 202 to compensate for errors (e.g., drift) in the position data received from the reach position component 260 and ensure that the controller 202 is accurately derating the speed of the extension actuator 176 based on the position of the extension body 174. By way of example, the reach position component 260 may generate inaccurate position data when the extension actuator 176 is attempting to drive the extension body 174 but the extension body 174 is contacting an obstacle (e.g., a hard stop, a refuse container, etc.) and is not moving, when a brake (e.g., a motor brake, etc.) of the extension actuator 176 is released without the extension actuator 176 being driven (e.g., allowing for drift of the extension actuator 176 and/or the extension body 174, etc.), and/or when a fault occurs in the extension actuator 176 (e.g., a motor fault occurs, etc.). In some embodiments, the controller 202 is configured to derate the speed of the extension actuator 176 to zero when the controller 202 receives the indication that the extension body 174 is in the retracted position.

According to an exemplary embodiment, at least one of the sensors 226 is configured as a proximity sensor configured to generate proximity data associated with the extension body 174 being in the retracted position. The controller 202 may receive the proximity data from the proximity sensor and identify the indication that the extension body 174 is in the retracted position based on the proximity data. By way of example, the proximity sensor may be a contact sensor that is actuated when the extension body 174 is in the retracted position. By way of another example, the proximity sensor may be a distance sensor that is configured to generate the proximity data indicating when the extension body 174 is in the retracted position. In other embodiments, the indication that the extension body 174 is in the retracted position is an increase in a force related to the extension actuator 176. By way of example, when the extension actuator 176 is a motor, the indication that the extension body 174 is in the retracted position may be an increase in torque in the extension actuator 176 due to the extension body 174 contacting the main body 172 in the retracted position (e.g., hitting a hard stop, etc.).

### Method of Position Based Control

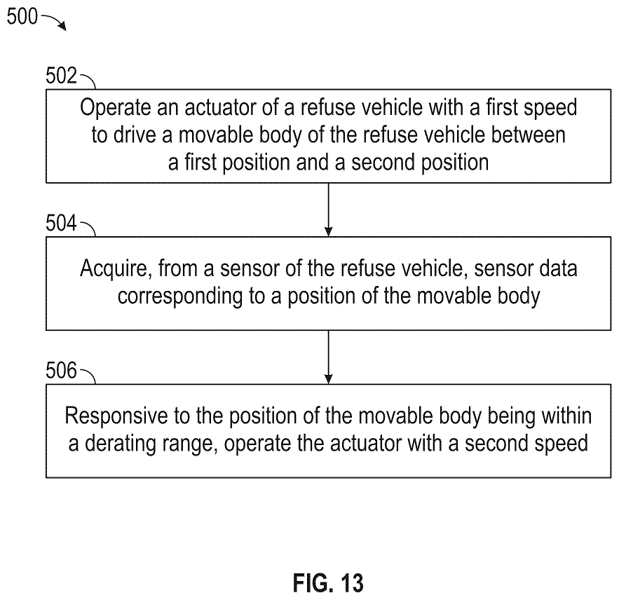

As shown in FIG. 13, a method 500 for operating an actuator of a vehicle includes steps 502-506. The method 500 may be executed by, for example, the controller 202 of the refuse vehicle 100. Further, any computing device described herein can be configured to perform at least a portion of the method 500 (e.g., the controller 202, the remote computing system 234, etc.). According to an exemplary embodiment, the method 500 is for operating an actuator of a lift system of a refuse vehicle based on a position of a movable body driven by the actuator between a first position and a second position. By way of example, the actuator may originally be operated with a first speed. When the position of the movable body approaches the first position and/or the second position, the actuator may be operated with a second derated speed that is lower than the first speed.

As shown in FIG. 13, the method 500 begins with operating an actuator of a refuse vehicle with a first speed at step 502. In some embodiments, the actuator is operated with the first speed to drive a movable body of the refuse vehicle between a first position and a second position. The actuator may be an actuator of the lift apparatus 216 (e.g., the extension actuator 176, the lift arm actuators 144, the grabber arm actuator 158, etc.) of the refuse vehicle 100 and the movable body may be a component of the lift apparatus 216 that is driven by the actuator of the lift apparatus 216. For example, step 502 may include operating the extension actuator 176 of the reach assembly 170 of the refuse vehicle 100 with a first speed to drive the extension body 174 between the extended position and the retracted position.

As shown in FIG. 13, the method 500 includes acquiring, from a component of a refuse vehicle, position data corresponding to a position of the movable body at step 504. In some embodiments, the position data is acquired from a component (e.g., a sensor) associated with a lift assembly of the refuse vehicle such that the movable body is a component of the lift assembly. For example, the component may generate position data corresponding to the movable body included in the lift assembly and provide the position data to a controller. The controller 202 may acquire the position data corresponding to the position of the extension body 174 from the reach position component 260.

As shown in FIG. 13, the method 500 includes, responsive to the position of the movable body being within a derating range, operating the actuator with a second speed at step 506. In some embodiments, the second speed is slower than the first speed such that the speed of the actuator is derated when the position of the movable body is within the derating range. In some embodiments, the actuator may be operated at a linearly decreasing speed as the movable body extends further into the derating range. The controller 202 may operate the extension actuator 176 with the second speed that equals the first speed of step 502 multiplied by a derating factor corresponding to the position of the extension body 174. For example, the controller 202 may operate the extension actuator 176 with the second speed that equals the first speed of step 502 multiplied by a derating factor from the actuator derating chart 300 and/or the reach assembly derating chart 400 based on the position of the extension body 174.

In some embodiments, the method 500 includes determining the derating range based on distance data corresponding to a distance between the movable body and an object. For example, a sensor may generate distance data corresponding to a distance between the movable body and an object and a controller may determine the derating range to correspond with the distance such that the speed of the actuator is derated as the movable body approaches the object. The object may be a refuse container such that the movable object does not contact the refuse container while traveling at full speed. In some embodiments, the distance data may be generated by a LIDAR sensor. For example, the LIDAR sensor may be positioned on the movable body and may generate the distance data corresponding to the distance between the movable body and the object.

In some embodiments, the method 500 includes zeroing the position data when the movable body is positioned in the first position and/or the second position. For example, when the movable body is in the first position and/or the second position, the controller may calibrate the position data to correspond with the first position and/or the second position. By zeroing the position data when the movable body is positioned in the first position and/or the second position, drift of the position data (e.g., errors in the position data, inaccuracies in the position data, etc.) may be prevented.

The present disclosure contemplates methods, systems, and program products on any machine-readable media for accomplishing various operations. The embodiments of the present disclosure may be implemented using existing computer processors, or by a special purpose computer processor for an appropriate system, incorporated for this or another purpose, or by a hardwired system. Embodiments within the scope of the present disclosure include program products comprising machine-readable media for carrying or having machine-executable instructions or data structures stored thereon. Such machine-readable media can be any available media that can be accessed by a general purpose or special purpose computer or other machine with a processor. By way of example, such machine-readable media can comprise RAM, ROM, EPROM, EEPROM, CD-ROM or other optical disk storage, magnetic disk storage or other magnetic storage devices, or any other medium which can be used to carry or store desired program code in the form of machine-executable instructions or data structures and which can be accessed by a general purpose or special purpose computer or other machine with a processor. When information is transferred or provided over a network or another communications connection (either hardwired, wireless, or a combination of hardwired or wireless) to a machine, the machine properly views the connection as a machine-readable medium. Thus, any such connection is properly termed a machine-readable medium. Combinations of the above are also included within the scope of machine-readable media. Machine-executable instructions include, for example, instructions and data which cause a general purpose computer, special purpose computer, or special purpose processing machines to perform a certain function or group of functions.

As utilized herein with respect to numerical ranges, the terms “approximately,” “about,” “substantially,” and similar terms generally mean +/−10% of the disclosed values. When the terms “approximately,” “about,” “substantially,” and similar terms are applied to a structural feature (e.g., to describe its shape, size, orientation, direction, etc.), these terms are meant to cover minor variations in structure that may result from, for example, the manufacturing or assembly process and are intended to have a broad meaning in harmony with the common and accepted usage by those of ordinary skill in the art to which the subject matter of this disclosure pertains. Accordingly, these terms should be interpreted as indicating that insubstantial or inconsequential modifications or alterations of the subject matter described and claimed are considered to be within the scope of the disclosure as recited in the appended claims.

It should be noted that the terms “exemplary” and “example” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like, as used herein, mean the joining of two members directly or indirectly to one another. Such joining may be stationary (e.g., permanent, etc.) or moveable (e.g., removable, releasable, etc.). Such joining may be achieved with the two members or the two members and any additional intermediate members being integrally formed as a single unitary body with one another or with the two members or the two members and any additional intermediate members being attached to one another.

References herein to the positions of elements (e.g., “top,” “bottom,” “above,” “below,” “between,” etc.) are merely used to describe the orientation of various elements in the Figures. It should be noted that the orientation of various elements may differ according to other exemplary embodiments, and that such variations are intended to be encompassed by the present disclosure.

Also, the term “or” is used in its inclusive sense (and not in its exclusive sense) so that when used, for example, to connect a list of elements, the term “or” means one, some, or all of the elements in the list. Conjunctive language such as the phrase “at least one of X, Y, and Z,” unless specifically stated otherwise, is otherwise understood with the context as used in general to convey that an item, term, etc. may be either X, Y, Z, X and Y, X and Z, Y and Z, or X, Y, and Z (i.e., any combination of X, Y, and Z). Thus, such conjunctive language is not generally intended to imply that certain embodiments require at least one of X, at least one of Y, and at least one of Z to each be present, unless otherwise indicated.

It is important to note that the construction and arrangement of the systems as shown in the exemplary embodiments is illustrative only. Although only a few embodiments of the present disclosure have been described in detail, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements. It should be noted that the elements and/or assemblies of the components described herein may be constructed from any of a wide variety of materials that provide sufficient strength or durability, in any of a wide variety of colors, textures, and combinations. Accordingly, all such modifications are intended to be included within the scope of the present inventions. Other substitutions, modifications, changes, and omissions may be made in the design, operating conditions, and arrangement of the preferred and other exemplary embodiments without departing from scope of the present disclosure or from the spirit of the appended claims.

What is claimed is:

1. A refuse vehicle comprising:
a chassis;
a body assembly coupled to the chassis;
a lift apparatus coupled to at least one of the chassis or the body assembly, the lift apparatus comprising:
a movable body; and
an actuator configured to move the movable body between a first position and a second position relative to the chassis; and
one or more processing circuits configured to:
operate the actuator with a first speed;
acquire position data corresponding to a position of the movable body; and
responsive to the position of the movable body being within a derating range, operate the actuator with a second speed that is slower than the first speed.

2. The refuse vehicle of claim 1, wherein:
the derating range extends to the second position when the actuator drives the movable body in a first direction from the first position towards the second position; and
the derating range extends to the first position when the actuator drives the movable body in a second direction from the second position towards the first position, the second direction opposite the first direction.

3. The refuse vehicle of claim 2, wherein:
the derating range extends past the second position when the actuator drives the movable body in the first direction from the first position towards the second position such that the actuator is operated at the second speed when the position of the movable body is past the second position; and
the derating range extends past the first position when the actuator drives the movable body in the second direction from the second position towards the first position such that the actuator is operated at the second speed when the position of the movable body is past the first position.

4. The refuse vehicle of claim 1, further comprising:
an energy storage system configured to store electrical energy, wherein the lift apparatus includes an inverter electrically coupled between the energy storage system and the actuator, the inverter configured to provide the electrical energy to the actuator to move the movable body, and wherein the one or more processing circuits acquires the position data from the inverter, the position data including characteristics of the electrical energy provided to the actuator.

5. The refuse vehicle of claim 1, wherein:
the lift apparatus includes:
a grabber mechanism coupled to the movable body, the grabber mechanism configured to grab a refuse container, and
a perception sensor coupled to the movable body, the perception sensor configured to generate perception data corresponding to the refuse container; and
the one or more processing circuits are configured to determine, based on the perception data, the second position of the movable body where the grabber mechanism is positioned to engage the refuse container.

6. The refuse vehicle of claim 5, wherein the derating range extends to the second position when the actuator drives the movable body in a direction from the first position towards the second position.

7. The refuse vehicle of claim 1, wherein, prior to operating the actuator with the second speed, the one or more processing circuits are configured to determine the second speed by multiplying the first speed by a derating factor.

8. The refuse vehicle of claim 7, wherein the derating factor decreases along the derating range in a direction of travel of the movable body.

9. The refuse vehicle of claim 8, wherein the derating factor decreases at a non-linear increasing rate along the derating range in the direction of travel of the movable body.

10. The refuse vehicle of claim 1, wherein, responsive to receiving an indication that the movable body is in the first position, the one or more processing circuits are configured to calibrate the position data by assigning the position of the movable body as the first position.

11. The refuse vehicle of claim 10, wherein the one or more processing circuits receive the indication that the movable body is in the first position from at least one of a proximity sensor or the actuator.

12. A refuse vehicle comprising:
a chassis;
a body assembly coupled to the chassis;
a lift apparatus coupled to at least one of the chassis or the body assembly, the lift apparatus comprising:
a movable body; and
an actuator configured to move the movable body between a first position and a second position; and
one or more processing circuits configured to:
operate the actuator at a first speed;
acquire position data corresponding to a position of the movable body between the first position and the second position;
determine, based on the position of the movable body, a derating factor for the actuator;
determine, based on the first speed and the derating factor, a second speed for the actuator; and
operate the actuator at the second speed.

13. The refuse vehicle of claim 12, wherein:
the derating factor is substantially equal to one in a non-derating range between the first position and the second position; and
the derating factor is less than one in one or more derating ranges positioned between at least one of (i) the non-derating range and (ii) the first position or the second position.

14. The refuse vehicle of claim 13, wherein:
a first of the one or more derating ranges extends from the non-derating range to the second position when the actuator drives the movable body in a first direction from the first position towards the second position; and
a second of the one or more derating ranges extends from the non-derating range to the first position when the actuator drives the movable body in a second direction from the second position towards the first position, the second direction opposite the first direction.

15. The refuse vehicle of claim 13, wherein the derating factor decreases along the one or more derating ranges in a direction of travel of the movable body.

16. The refuse vehicle of claim 15, wherein the derating factor decreases at a non-linear increasing rate along the one or more derating ranges in the direction of travel of the movable body.

17. The refuse vehicle of claim 12, wherein, responsive to receiving an indication that the movable body is in the first position, the one or more processing circuits are configured to calibrate the position data by assigning the position of the movable body as the first position.

18. A method of operating an actuator of a refuse vehicle, the method comprising:
operating the actuator at a first speed to move a movable body relative to a chassis of the refuse vehicle between a first position and a second position;
acquiring position data corresponding to a position of the movable body; and
responsive to the position of the movable body being within a derating range, operating the actuator at a second speed, the second speed slower than the first speed.

19. The method of claim 18, further comprising, responsive to receiving an indication that the movable body is in the first position, calibrating the position data by assigning the position of the movable body as the first position.

20. The method of claim 18, wherein, prior to operating the actuator with the second speed, the method further comprises determining the second speed by multiplying the first speed by a derating factor, the derating factor decreasing along the derating range in a direction of travel of the movable body.
